(19) United States
(12) Patent Application Publication
(10) Pub. No.: US 2023/0257309 A1
(43) Pub. Date: Aug. 17, 2023

(54) Composite Materials Including Nanofibers and Ceramics and Methods

(71) Applicant: The Florida State University Research Foundation, Inc., Tallahassee, FL (US)

(72) Inventors: Zhibin Yu, Tallahassee, FL (US); Rebekah Sweat, Tallahassee, FL (US)

(21) Appl. No.: 18/167,495

(22) Filed: Feb. 10, 2023

Related U.S. Application Data
(60) Provisional application No. 63/309,264, filed on Feb. 11, 2022.

(51) Int. Cl. C04B 35/80; C04B 35/626; C04B 35/64; C04B 35/622

(52) U.S. Cl. CPC C04B 35/80; C04B 35/6264; C04B 35/64; C04B 35/62218; C04B 35/62222; C04B 2235/524; C04B 2235/3826; C04B 2235/6562; C04B 2235/6565

(57) ABSTRACT

Composite materials that include a plurality of nanofibers and a ceramic. Methods of forming composite materials, which may include removing a liquid from a dispersion that includes a plurality of nanofibers, a pre-ceramic precursor, and a liquid to form an intermediate material, and annealing the intermediate material. A pre-ceramic precursor may be added before or after removal of a liquid. An article having a surface on which a composite material is disposed.

### CROSS-REFERENCE TO RELATED PATENT APPLICATIONS

This application claims priority to U.S. Provisional Patent Application No. 63/309,264, filed Feb. 11, 2022, which is incorporated by reference herein.

### BACKGROUND

Ceramics and composite materials that include ceramics can be useful in certain applications, especially applications in which the ceramics or composite materials are exposed to high temperatures and/or extreme environments. Ceramics and composite materials that include ceramics, however, can be brittle and crack easily, especially when exposed to mechanical and/or thermal shock.

Conventional ceramic manufacturing techniques, especially those using polymer derived ceramic precursors, typically require a low heating/cooling rate (e.g., 1° C. per minute or lower) to or from 1200° C. (or greater), which can require about 40 hours per manufacturing cycle. If a heating/cooling rate of 1° C. per minute is exceeded, the conventional materials can suffer a very high risk of cracking and/or other physical defects during or after the heating/cooling process.

There remains a need for improved composite materials, such as composite materials that include ceramics, especially composite materials with improved mechanical shock resistance, thermal shock resistance, or a combination thereof. There also remains a need for improved methods for producing composite materials that include ceramics, including methods that use increased heating rates, increased cooling rates, or a combination thereof to shorten the manufacturing cycle.

### BRIEF SUMMARY

Provided herein are composite materials, embodiments of which include a nanofiber (e.g., nanowire or nanotube) incorporated in a ceramic matrix. Embodiments of the composite materials described herein may exhibit enhanced mechanical properties, improved thermal shock resistance, or a combination thereof. Additionally or alternatively, embodiments of the composite materials described herein may be fabricated with increased manufacturing speed (e.g., fast throughput). For example, embodiments of the composite materials described herein may be fabricated using a significantly increased heating/cooling rate during annealing, such as about 40° C. per minute to or from 1200° C., which can result in a shortened manufacturing cycle, such as a manufacturing cycle of about one hour.

In one aspect, methods of forming composite materials are provided. In some embodiments, the methods include providing a dispersion that includes a plurality of nanofibers, a pre-ceramic precursor, and a liquid; removing at least a portion of the liquid from the dispersion to form an intermediate material; and annealing the intermediate material for a time and a temperature effective to convert the pre-ceramic precursor to a ceramic. In some embodiments, the methods include providing a dispersion that includes a plurality of nanofibers and a liquid; removing at least a portion of the liquid from the dispersion to form an intermediate material, such as a filtration cake; contacting the intermediate material with a pre-ceramic precursor to at least partially infiltrate the intermediate material with the pre-ceramic precursor; and annealing the intermediate material to convert the pre-ceramic precursor to a ceramic. The annealing may include heating the intermediate material, cooling the intermediate material, or heating and cooling the intermediate material at a rate of greater than about 1° C., or greater than about 10° C., such as about 20° C. to about 100° C. per minute, or about 40° C. to about 100° C. per minute.

In another aspect, composite materials are provided. In some embodiments, the composite materials include a plurality of nanofibers; and a ceramic matrix in which the plurality of nanotubes is incorporated. The plurality of nanofibers may include boron nitride nanotubes (BNNTs). The ceramic matrix may be a silicon carbide matrix.

In a further aspect, articles are provided. In some embodiments, the articles have a surface, and a composite material described herein is disposed on the surface of the article.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 depicts a plot of the weight ratio of an embodiment of a nanoscale fiber versus the concentration of an embodiment of a ceramic precursor in embodiments of composite materials before and after annealing.

FIG. 2 depicts a plot of weight loss versus annealing temperature for several embodiments of composite materials.

### DETAILED DESCRIPTION

Provided herein are methods of forming composite materials, composite materials, and articles. The methods may include annealing an intermediate material by an annealing process that includes heating the intermediate material at a rate of greater than 1° C. to produce a composite material, which may be a crack-free composite material. The composite materials and intermediate materials, in other words, may withstand the annealing processes described herein without cracking or suffering one or more other physical defects, despite the relatively high heating ramp rates of the annealing processes.

### Methods

In one aspect, methods of forming composite materials are provided herein. In some embodiments, the methods include providing a dispersion that includes a plurality of nanofibers, a pre-ceramic precursor, and a liquid; removing at least a portion of the liquid from the dispersion to form an intermediate material; and annealing the intermediate material for a time and a temperature effective to convert the pre-ceramic precursor to a ceramic.

In some embodiments, the methods include providing a dispersion that includes a plurality of nanofibers and a liquid; removing at least a portion of the liquid from the dispersion to form an intermediate material, such as a filtration cake; contacting the intermediate material with a pre-ceramic precursor to at least partially infiltrate the intermediate material with the pre-ceramic precursor; and annealing the intermediate material for a time and a temperature effective to convert the pre-ceramic precursor to a ceramic.

As used herein, the term “dispersion” refers to a composition in which one phase, such as a nanofiber phase, is dispersed in another phase, such as a liquid. In some embodiments, the dispersion includes a plurality of nanofibers and a liquid. In some embodiments, the dispersion includes a plurality of nanofibers, a pre-ceramic precursor, and a liquid. The dispersions described herein may be substantially uniform dispersions.

At least a portion of a plurality of nanofibers may be present as agglomerates (e.g., “bundles”) in a dispersion. In some embodiments, the methods include sonicating the dispersion. The sonicating of the dispersion may include sonicating the dispersion for a time effective to (i) separate nanofibers of one or more agglomerates, (ii) uniformly disperse the plurality of nanotubes in the liquid, or (iii) a combination thereof.

At least a portion of a liquid may be removed from a dispersion described herein using any known technique. In some embodiments, the removing of at least a portion of a liquid from a dispersion includes filtering the dispersion with a filter. When a filter is used to remove at least a portion of a liquid from a dispersion, the resulting intermediate material may be a filtration cake. The intermediate material, such as a filtration cake, may be removed from a filter, such as a membrane, prior to annealing. The filtration of a dispersion may be aided by a pressure differential, such as a vacuum, positive pressure, etc.

Any suitable filter, such as a membrane, may be used to filter the dispersions described herein. In some embodiments, the filter, e.g., membrane, has a pore size of about 0.01 μm to about 100 μm, about 0.01 μm to about 90 μm, about 0.01 μm to about 80 μm, about 0.01 μm to about 70 μm, about 0.01 μm to about 60 μm, about 0.01 μm to about 50 μm, about 0.01 μm to about 40 μm, about 0.01 μm to about 30 μm, or about 0.01 μm to about 20 μm. In some embodiments, the membrane comprises cellulose paper or nylon.

In some embodiments, the removing of at least a portion of a liquid from a dispersion includes depositing a dispersion on a substrate. The depositing of the dispersion on the substrate may include spray coating, spin coating, painting/brushing, drop casting, screen-printing, or doctor blading the dispersion on the substrate. The substrate may include any suitable material, such as plastic, glass, silicon, or a combination thereof. When at least a portion of a liquid is removed from a dispersion by depositing the dispersion on a substrate, the intermediate material may be in the form of a film. An intermediate material, such as a film, may be removed from a substrate prior to annealing.

When a dispersion does not include a pre-ceramic precursor (or an entire desired amount of pre-ceramic precursor), then the methods described herein may include contacting the intermediate material, such as a filtration cake, with a pre-ceramic precursor to at least partially infiltrate the intermediate material with the pre-ceramic precursor.

An intermediate material, such as a filtration cake, is “at least partially infiltrated” with a pre-ceramic precursor when the pre-ceramic precursor contacts one or more sub-surface nanofibers of the intermediate material.

A pressure gradient (e.g., positive pressure, vacuum, etc.) may be used to facilitate or ease the infiltration of an intermediate material with a pre-ceramic precursor. The pre-ceramic precursor may be infiltrated alone or in combination with another material, such as a solvent. The solvent may be an organic solvent, including, but not limited to, hexanes, tetrahydrofuran, toluene, or a combination thereof. The pre-ceramic precursor may be present in the solvent at any concentration. For example, the pre-ceramic precursor may be present in the solvent at a concentration of about 0.01 wt % to about 90 wt %, about 0.01 wt % to about 80 wt %, about 0.01 wt % to about 70 wt %, about 0.01 wt % to about 60 wt %, about 0.01 wt % to about 50 wt %, about 0.01 wt % to about 40 wt %, or about 0.01 wt % to about 30 wt %, based on the total weight of the solvent and the pre-ceramic precursor.

The annealing of intermediate materials, such as filtration cakes, may include heating the intermediate materials at a rate of greater than 1° C. per minute, greater than 2° per minute, greater than 3° C. per minute, greater than 4° C. per minute, greater than 5° C. per minute, greater than 6° C. per minute, greater than 7° C. per minute, greater than 8° C. per minute, greater than 9° C., or greater than 10° C. per minute. Not wishing to be bound by any particular theory, it is believed that these increased minimum ramp rates that may be used to heat intermediate materials during annealing may shorten the manufacturing cycle of the composite materials described herein relative to conventional composite materials, which, as explained herein, typically require ramp rates of 1° C. or less per minute.

In some embodiments, the annealing includes heating and/or cooling an intermediate material at a rate of about 10° C. per minute to about 100° C. per minute, about 10° C. per minute to about 90° C. per minute, about 10° C. per minute to about 80° C. per minute, about 10° C. per minute to about 70° C. per minute, about 10° C. per minute to about 60° C. per minute, about 10° C. per minute to about 50° C. per minute, about 10° C. per minute to about 40° C. per minute, about 10° C. per minute to about 30° C. per minute, about 10° C. per minute to about 20° C. per minute, about 20° C. per minute to about 100° C. per minute, about 20° C. per minute to about 50° C. per minute, about 30° C. per minute to about 50° C. per minute, or about 40° C. per minute.

In some embodiments, the annealing includes cooling the intermediate material at a rate of about 1° C. per minute to about 50° C. per minute, about 1° C. per minute to about 40° C. per minute, about 1° C. per minute to about 30° C. per minute, about 1° C. per minute to about 20° C. per minute, about 1° C. per minute to about 10° C. per minute, about 2° C. per minute to about 10° C. per minute, about 3° C. per minute to about 10° C. per minute.

The annealing of intermediate materials may occur, in whole or in part, in air, an inert gas, or a combination thereof. The inert gas may include nitrogen, argon, or helium.

As used herein, the term “nanofiber” refers to particles having at least one nanoscale (i.e., about 0.1 nm to less 1,000 nm) dimension (e.g., diameter, length, etc.), including, but not limited to, nanowires, nanotubes, etc. In some embodiments, the plurality of nanofibers includes boron nitride nanofibers, such as boron nitride nanotubes. Other types of nanofibers are envisioned.

As used herein, the phrase “pre-ceramic precursor” refers to a material that can be converted to a ceramic by any of the annealing processes described herein. The ceramic may be stable to a temperature up to at least 1,800° C. in air, or up to at least 2,200° C. in an inert atmosphere. The pre-ceramic precursor may include a polymer, which may be a liquid at room temperature and atmospheric pressure. The ceramic formed from the pre-ceramic precursor may be a silicon carbide ceramic. The silicon carbide ceramic may have an atomic ratio of silicon to carbon of about 0.9:1.1 to about 1.1:0.9, or about 1:1. In some embodiments, the pre-ceramic precursor includes STARPCS™ SMP-10 silicon carbide precursor (Starfire Systems, USA).

Any liquid may be included in the dispersions described herein. In some embodiments, the liquid includes (or consists of) water. In some embodiments, the liquid includes (or consists of) an organic liquid. In some embodiments, the liquid includes (or consists of) two different organic liquids. In some embodiments, the liquid includes water and at least one organic liquid. The liquids may be selected based on the solubility of a pre-ceramic precursor in the liquids. For example, a liquid in which a pre-ceramic precursor is insoluble (e.g., <1 g/L) may be used.

### Composite Materials and Articles

Also provided herein are composite materials, including those made according to the methods described herein.

In some embodiments, the composite materials include a plurality of nanofibers incorporated in a ceramic matrix. The plurality of nanofibers may include any of those described herein, such as boron nitride nanotubes. The ceramic matrix may include any ceramic material. In some embodiments, the ceramic material includes silicon carbide.

The plurality of nanofibers may be present at an amount of about 5% to about 75%, about 5% to about 70%, about 5% to about 65%, about 5% to about 60%, about 5% to about 55%, about 5% to about 50%, about 5% to about 40%, about 5% to about 30%, about 5% to about 20%, by weight, based on the weight of the composite material.

Also provided herein are articles of manufacture. A composite material described herein may be disposed on or in an article, such as on a surface of an article. The article may include any article that is likely to be exposed to high temperatures, such as part of a vehicle (e.g., an aircraft).

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When composite materials, articles, or methods are claimed or described in terms of “comprising” various steps or components, the composite materials, articles, or methods can also “consist essentially of” or “consist of” the various steps or components, unless stated otherwise.

The terms “a,” “an,” and “the” are intended to include plural alternatives, e.g., at least one. For instance, the disclosure of “a liquid”, “a pre-ceramic precursor”, and the like, is meant to encompass one, or mixtures or combinations of more than one liquid, pre-ceramic precursor, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the annealing comprises heating or cooling the film or filtration cake at a rate of about 35° C. to about 45° C. This range should be interpreted as encompassing about 35° C. and about 45° C., and further encompasses “about” each of 36° C., 37° C., 38° C., 39° C., 40° C., 41° C., 42° C., 43° C., and 44° C., including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Fabrication of Composite Material

Boron nitride nanotubes (BNNTs) were used as the nanofibers in this example. The BNNTs were dispersed in water, one or more organic liquids, or a combination thereof.

When the dispersions of this example were prepared, sonication was used to form a substantially uniform dispersion. Not wishing to be bound by any particular theory, it was believed that sonication facilitated or aided the separation of bundles of BNNTs that may have been present in the dispersion. The sonication was, in some instances, combined with stirring.

In this example, three different procedures were used to fabricate several composite materials.

In this example, STARPCS™ SMP-10 silicon carbide precursor (Starfire Systems, USA)(“SMP-10”) was used as the pre-ceramic precursor, which resulted in the formation of silicon carbide (SiC) ceramic matrix after high temperature annealing (see Example 2).

Procedure 1: Procedure 1 of this example included adding a pre-ceramic precursor to a dispersion of BNNTs in a liquid, filtering the BNNT/pre-ceramic precursor/liquid mixture through a membrane, and collecting the filtration cake from the membrane for further treatment (see Example 2). A cellulose paper membrane or a nylon membrane was used to filter the dispersion in this procedure. The membrane had a pore size of about 0.01 μm to 100 μm.

Procedure 2: Procedure 2 of this example included adding a pre-ceramic precursor to a dispersion of BNNTs; depositing the BNNT/pre-ceramic precursor/liquid mixture onto a solid substrate using spray coating, spin coating, painting/brushing, drop casting, screen printing, and/or doctor blading. Some samples were kept on the substrate during the annealing, and other samples were peeled off of the substrate for further treatment (see Example 2).

Procedure 3: Procedure 3 of this example included filtering a dispersion that included BNNTs dispersed in a liquid through a membrane (see Procedure 1) to produce a filtration cake; and then infiltrating the filtration cake at least partially with the pre-ceramic precursor in a pristine or diluted state. When diluted in a solvent, the pre-ceramic precursor was present at concentrations ranging from 0.001 wt % to 99 wt %. The filtration cake was kept on the membrane when infiltrated with the pre-ceramic precursor. The filtration cake then was collected for further treatment (see Example 2).

The products of each of Procedures 1-3 were then annealed, as explained at Example 2.

### Example 2—Annealing and Comparative Testing

The products of Procedures 1-3 of Example 1 were annealed as explained in this example.

The products were annealed in air at a temperature of about 20° C. to about 600° C. for about 1 minute to about 10 hours.

The products were then transferred to an inert environment (e.g., nitrogen, argon, helium, etc.) for additional annealing.

In this example, the annealing of several samples included the following parameters: a 15 minute ramp rate from 25° C. to 400° C., maintained at 400° C. for 30 minutes, increased to 800° C. in 30 minutes, maintained at 800° C. for 30 minutes, increased to 1200° C. in 30 minutes, and maintained at 1200° C. for 30 minutes.

The temperature cooling rate of this example was 1° C. per minute to 50° C. per minute to 25° C.

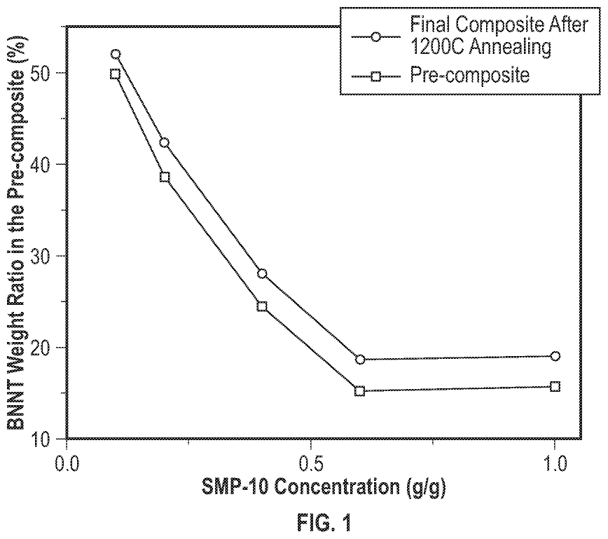

Using Procedure 3, a series of composite materials were fabricated. The concentration of SMP-10 in a solvent was varied during the infiltration, which resulted in composite materials having different BNNT ratios in (i) the pre-composite filtration cake (i.e., before high temperature sintering), and (ii) the final ceramic composite after high temperature sintering, as depicted at FIG. 1.

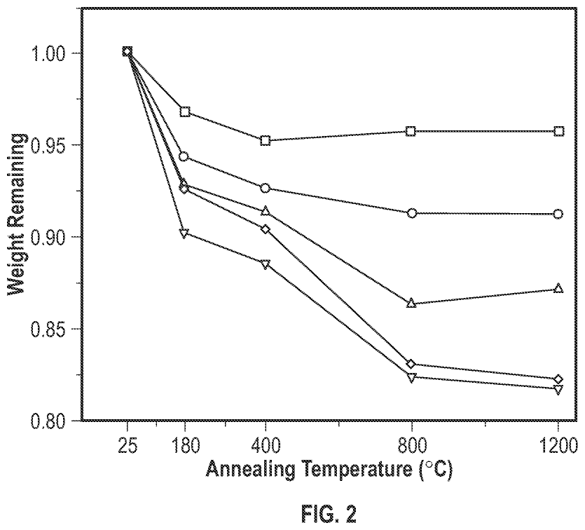

Also analyzed was the weight loss of the BNNT/pre-ceramic precursor during high temperature sintering for samples with a BNNT weight ratio from 10% to 60%. The results are depicted at FIG. 2.

A number of photographs were taken to assess the effects of the annealing process of this example. For example, using Procedure 3, a circular film was created. After the film was maintained at 400° C. for 30 minutes, according to the foregoing annealing process, the film was slightly yellow in color, and retained most of its transparency. However, after the film was maintained at 800° C. for 30 minutes, according to the foregoing annealing process, the film was black in color, with no transparency. Visually, the films' appearance did not change much, if at all, after the film was maintained at 1200° C. for 30 minutes, according to the foregoing annealing process.

The photographs collected of the materials at various stages of the methods permitted an assessment of the shrinkage that was observed for some materials.

Again, using Procedure 3, circular films were created, and the diameters of the films were measured before and after the films were subjected to the foregoing annealing process. The diameters of the films decreased about 15% to about 25% due to the foregoing annealing process. For example, one circular film had a diameter of about 38 mm prior to annealing, and a diameter of about 30 mm after the foregoing annealing process, which was a decrease of about 21%.

The photographs also revealed that the processes of Examples 1 and 2 produced relatively large, crack-free samples.

Using the methods of this example, composite materials were made having different configurations, such as films (e.g., the circular films described above), rings, ribbons, etc.

Control samples were made using Procedures 1-3, but without adding BNNTs. In one test, an SMP-10 pre-ceramic precursor was spin-coated onto a substrate of silicon or glass. In another test, an SMP-10 pre-ceramic precursor was drop-coated onto a silicon substrate. All of the samples made in this manner cracked after the first stage of the foregoing annealing process, i.e., the annealing in air. For example, the samples made by drop coating the pre-ceramic precursor onto silicon cracked after annealing for 30 minutes at 400° C. These results indicated that the comparative materials succumbed to thermal shock, so the comparative materials were annealed at a heating/cooling rate of about 1° C. per minute or less. When this low ramp rate was used, crack-free samples of the comparative materials were obtained. This test demonstrated the surprising nature of the ability of the composite materials of Procedures 1-3 to withstand, without cracking, the foregoing annealing process.

Thermal shock testing of the composite materials prepared according to Examples 1 and 2 also was conducted. Multiple embodiments of the samples were burned with a propane torch (˜1800° C.) in air. The heated samples were then immediately quenched in ice water. The samples were then removed from the ice water. Each of the composite materials made according to Procedures 1-3 tolerated the high temperature shock test without cracking.

Mechanical shock testing of the composite materials prepared according to Examples 1 and 2 also was conducted. The samples were dropped from a height of about 1.5 m onto a concrete floor, and this impact did not break the samples.

The composite materials prepared according to Examples 1 and 2 also were rigid. The composite materials, for example, were capable of scratching and breaking glass and a silicon wafer.

The composite materials prepared according to Examples 1 and 2 also exhibited a relatively large change of resistance with temperature. In one test, a BNNT/SiC composite material had a resistance that decreased from 1.42 MΩ at room temperature to 0.54 MΩ at 180° C.

The composite materials of this example also were post-processed using a laser cutter, which permitted the composite materials to be cut into a number of desired shapes.

1. A method of forming a composite material, the method comprising:
providing a dispersion comprising a plurality of nanofibers, a pre-ceramic precursor, and a liquid;
removing at least a portion of the liquid from the dispersion to form an intermediate material; and
annealing the intermediate material for a time and a temperature effective to convert at least a portion of the pre-ceramic precursor to a ceramic, wherein the annealing comprises heating the intermediate material at a rate of greater than 1° C. per minute.

2. The method of claim 1, wherein the annealing comprises—
(i) heating the intermediate material at a rate of about 10° C. to about 100° C. per minute;
(ii) cooling the intermediate material at a rate of about 1° C. to about 50° C. per minute; or
(iii) a combination thereof.

3. The method of claim 1, wherein the removing of the at least a portion of the liquid comprises filtering the dispersion with a filter.

4. The method of claim 3, wherein the filter comprises a membrane having a pore size of about 0.01 μm to about 100 μm.

5. The method of claim 3, wherein the membrane comprises cellulose paper or nylon.

6. The method of claim 1, wherein the removing of the at least a portion of the liquid comprises depositing the dispersion on a substrate, and wherein the intermediate material is in the form of a film.

7. The method of claim 6, further comprising removing the film from the substrate prior to the annealing.

8. The method of claim 6, wherein the depositing of the dispersion on the substrate comprises spray coating, spin coating, or drop casting the dispersion on the substrate.

9. The method of claim 1, wherein the liquid comprises an organic liquid.

10. The method of claim 1, further comprising sonicating the dispersion prior to the removing of the at least a portion of the liquid.

11. The method of claim 10, wherein the sonicating of the dispersion comprises sonicating the dispersion for a time effective to uniformly disperse the plurality of nanofibers in the liquid.

12. The method of claim 1, wherein the plurality of nanofibers comprises boron nitride nanotubes.

13. The method of claim 1, wherein the pre-ceramic precursor is a silicon carbide precursor.

14. A method of forming a composite material, the method comprising:
providing a dispersion comprising a plurality of nanofibers and a liquid;
removing at least a portion of the liquid from the dispersion to form an intermediate material;
contacting the intermediate material with a pre-ceramic precursor to at least partially infiltrate the intermediate material with the pre-ceramic precursor; and
annealing the intermediate material to convert the pre-ceramic precursor to a ceramic, wherein the annealing comprises heating the intermediate material at a rate of greater than 1° C. per minute.

15. The method of claim 14, wherein the annealing comprises heating the intermediate material at a rate of about 10° C. to about 100° C. per minute.

16. The method of claim 14, wherein prior to the contacting of the intermediate material with the pre-ceramic precursor, the pre-ceramic precursor is dissolved in a solvent.

17. The method of claim 14, wherein the plurality of nanofibers comprises boron nitride nanotubes, and wherein the pre-ceramic precursor is a silicon carbide ceramic precursor.

18. A composite material comprising:
a plurality of nanofibers; and
a ceramic matrix in which the plurality of nanofibers is incorporated;
wherein the plurality of nanofibers comprises boron nitride nanotubes.

19. The composite material of claim 18, wherein the plurality of nanofibers is present at an amount of about 5% to about 55%, by weight, based on the weight of the composite material.

20. An article having a surface on which the composite material of claim 18 is disposed.
